(19) United States
(12) Patent Application Publication
(10) Pub. No.: US 2020/0301105 A1
(43) Pub. Date: Sep. 24, 2020

(54) OPTICAL PHOTOGRAPHING LENS SYSTEM

(71) Applicant: ACE SOLUTECH CO., LTD.

(72) Inventors: Pil Sun JUNG, Gyeonggi-do (KR); Dong Young KIM, Gyeonggi-do (KR); Chi Ho AN, Gyeonggi-do (KR)

(21) Appl. No.: 16/086,201

(22) PCT Filed: Mar. 16, 2017
(86) PCT No.: PCT/KR2017/002832

§ 371 Date: Sep. 18, 2018

(30) Foreign Application Priority Data
Mar. 18, 2016 (KR) 10-2016-0032934

(51) Int. Cl. G02B 9/64; G02B 13/00; G02B 7/02

(52) U.S. Cl. CPC G02B 9/64; G02B 13/0045; G02B 7/02; G02B 13/006

(57) ABSTRACT

Provided is an optical photographing lens system. The optical lens system includes a first lens, a second lens, a third lens, a fourth lens, a fifth lens, a sixth lens, and a seventh lens that are sequentially arranged from an object toward an image sensor. The fifth lens has a positive (+) power and the sixth lens has a negative (−) power, and the fifth lens and the sixth lens are cemented together to form a cemented lens having a positive (+) power.

### CROSS REFERENCE TO RELATED APPLICATIONS

This application is the National Stage of International Application No. PCT/KR2017/002832, having an International Filing Date of 16 Mar. 2017, which designated the United States of America, and which International Application was published under PCT Article 21(2) as WO Publication No. 2017/160092 A1, which claims priority from and the benefit of Korean Patent Application No. 10-2016-0032934, filed on 18 Mar. 2016, the disclosures of which are incorporated herein by reference in their entireties.

### BACKGROUND

### 1. Field

The present disclosure relates to an optical apparatus, and more particularly, to an optical lens system applied to an imaging apparatus.

### 2. Description of Related Developments

Semiconductor image sensors have been used in all applications that need or require image capturing, including applications for industrial, domestic, and recreational purposes.

As the performance of semiconductor image sensors such as charge-coupled devices (CCDs) or complementary metal oxide semiconductors (CMOSs) has greatly improved, their applications have increased considerably. Due to the innovation of semiconductor image sensors and the rapid increase in pixel density, it is possible to capture images of a small size and extremely high resolutions.

High-quality optical lens systems suitable for such image sensors having a high number of pixels are required. High-quality optical systems, in particular, ultra-wide-angle optical systems, need to have a high sharpness and a small aberration in all areas.

Not only high-quality imaging devices but also optical lens systems suitable for the high-quality imaging devices are necessary to obtain high-quality images.

Optical lens systems applied to small cameras (e.g., cameras for mobile phones), vehicle cameras (e.g., cameras for black boxes, around view monitor systems (AVMs), or rear views), and various action cameras (e.g., cameras for drones or sports cameras) need to maintain high performance while having a small size.

Thus, there remains a need for studies on lenses for small cameras that may have optical performance better than that required for optical designs, may be easily formed and processed, may be easily miniaturized, and may reduce manufacturing costs.

### SUMMARY

The present disclosure provides an ultra-wide-angle optical lens system that may be used for various purposes.

The present disclosure provides an optical lens system that may be easily miniaturized, may have high optical performance, and may reduce manufacturing costs.

An optical lens system according to the present disclosure includes: a first lens having a negative (−) power; a second lens having a negative (−) power; a third lens having a positive (+) power; a fourth lens having a positive (+) power; a fifth lens having a positive (+) power; a sixth lens having a negative (−) power; and a seventh lens having a positive (+) power, wherein the fifth lens and the sixth lens are cemented together to form a cemented lens having a positive (+) power.

According to a specific embodiment of the present disclosure, the first lens has an exit surface that is concave away from an image plane, the second lens has an exit surface that is concave away from the image plane, the third lens has an incident surface that is convex toward an object, the fourth lens has an exit surface that is convex toward the image plane, the fifth lens has an exit surface that is convex toward the image plane, the sixth lens has an incident surface that is concave away from the object, and the seventh lens has an incident surface that is convex toward the object.

According to a specific embodiment of the present disclosure, the optical lens system may satisfy at least one of Conditions 1 through 6.

140≤Fov≤240, <Condition 1>

where field of view (Fov) is a diagonal viewing angle of the optical lens system.

0≤RL1S2/RL2S2≤5, <Condition 2>

where RL1S2 is a curvature (R) value of a second surface of the first lens, and RL2S2 is an R value of a second surface of the second lens, wherein the second surface of the first lens faces an image sensor.

0≤ThiL5L6≤0.03, <Condition 3>

where ThiL5L6 is an interval or a gap (T) between a second surface of the fifth lens and a first surface of the sixth lens that constitute the cemented lens.

0.15≤(L1toL2)/OAL≤0.4, <Condition 4>

where L1toL2 is a thickness from the first lens to the second lens, and an overall length (OAL) is a thickness (length) between a central portion of the first lens and a central portion of the seventh lens.

0.7≤Ind1/Ind7≤1.5, <Condition 5>

where Ind1 and Ind7 are respectively refractive indices of materials of the first lens and the seventh lens.

0.5≤Abv1/Abv7≤2, <Condition 6>

where Abv1 and Abv7 are respectively Abbe numbers of the materials of the first lens and the seventh lens.

An ultra-wide-angle optical lens system that may have a small size, high performance, and a high resolution may be realized. In more detail, an optical lens system according to an embodiment of the present disclosure may include first through seventh lenses respectively having negative (−), negative (−), positive (+), positive (+), positive (+), negative (−), and positive (+) powers and sequentially arranged from an object to an image sensor, and may satisfy at least one of Conditions 1 through 6. The optical lens system may be applied as an ultra-wide-angle optical apparatus to not only general photographing apparatuses but also vehicle cameras (e.g., cameras for black boxes, around view monitor systems (AVMs), or rear views) and various action cameras (e.g., cameras for drones or sports cameras).

### BRIEF DESCRIPTION OF DRAWINGS

FIG. 1 is a cross-sectional view illustrating an arrangement of main elements of an optical lens system according to a first embodiment of the present disclosure.

FIG. 2 is a cross-sectional view illustrating an arrangement of main elements of an optical lens system according to a second embodiment of the present disclosure.

FIG. 3 is a cross-sectional view illustrating an arrangement of main elements of an optical lens system according to a third embodiment of the present disclosure.

FIG. 4 illustrates a longitudinal spherical aberration, an astigmatic field curvature, and a distortion of the optical lens system according to the first embodiment of the present disclosure.

FIG. 5 illustrates a longitudinal spherical aberration, an astigmatic field curvature, and a distortion of the optical lens system according to the second embodiment of the present disclosure.

FIG. 6 illustrates a longitudinal spherical aberration, an astigmatic field curvature, and a distortion of the optical lens system according to the third embodiment of the present disclosure.

### DETAILED DESCRIPTION

An optical lens system according to an embodiment of the present disclosure will now be described in detail with reference to the attached drawings. The same reference numerals denote the same (similar) elements throughout the detailed description.

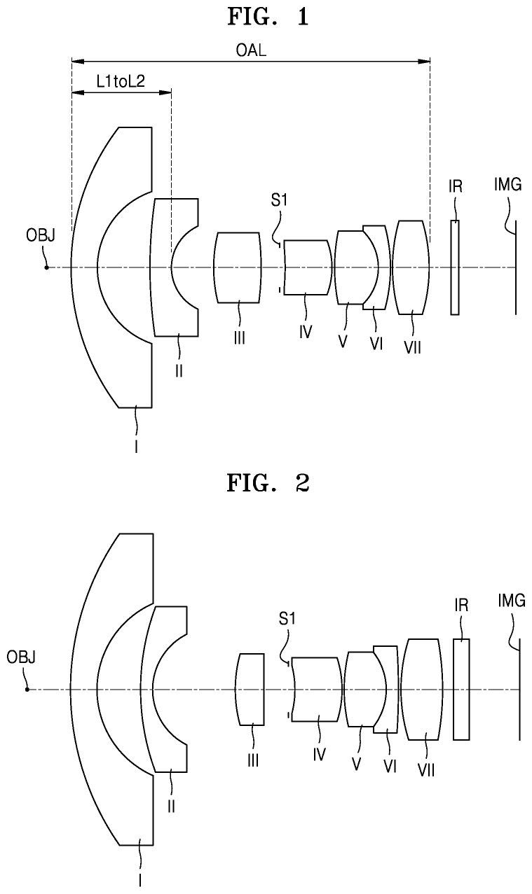

FIGS. 1 through 3 are cross-sectional views illustrating optical lens systems according to first through third embodiments of the present disclosure.

As shown in FIGS. 1 through 3, an optical lens system includes seven lenses that are located between an object OBJ and an image sensor IMG having an image plane on which an image of the object OBJ is formed and are sequentially arranged from the object OBJ. An incident surface refers to a surface facing the object OBJ, and an exit surface refers to a surface facing the image sensor IMG.

Each of the seven lenses has an incident surface on which light is incident, that is, a surface facing the object OBJ, and an exit surface from which light is emitted, that is, a surface facing the image sensor IMG. The six (seven?) lenses include a first lens I, a second lens II, a third lens III, a fourth lens IV, a fifth lens V, a sixth lens VI, and a seventh lens VII.

The first lens I that is a large aperture lens has a negative (−) power (refractive index). According to an embodiment of the present disclosure, the first lens I may have a meniscus shape convex toward the object OBJ.

The second lens II that is a large aperture lens smaller than the first lens I has a negative (−) power (refractive index). According to an embodiment of the present disclosure, the second lens II may have a meniscus shape convex toward the object OBJ.

The third lens III has a positive (+) power, and may be a biconvex lens according to an embodiment of the present disclosure.

The fourth lens IV has a positive (+) power, and may be a lens whose exit surface is convex toward the image sensor IMG according to an embodiment of the present disclosure.

The fifth lens V has a positive (+) power, and may be a biconvex lens whose both surfaces are convex according to an embodiment of the present disclosure.

The sixth lens VI has a negative (−) power, and may be a meniscus lens convex toward the image sensor IMG.

Curvatures R of the exit surface of the fifth lens V and the incident surface of the sixth lens VI may be the same, and the fifth lens V and the sixth lens VI may be separated from each other by a predetermined interval or distance T, e.g., a fine interval of up to 0.03 mm, according to an embodiment of the present disclosure or may be cemented together with an extremely small gap T (virtually T=0.0000) therebetween according to another embodiment of the present disclosure.

For example, the fifth lens V and the sixth lens VI may be cemented together (T=0.0000) to form a cemented lens having a positive (+) power as shown in the first embodiment through the third embodiment according to the present disclosure, or the fifth lens V and the sixth lens VI may be separated from each other by a distance or interval of up to 0.03 mm according to another embodiment.

The seventh lens has a positive (+) power, and may be a biconvex lens whose incident surface and exit surface are respectively convex toward the object OBJ and the image sensor IMG according to an embodiment of the present disclosure.

An optical lens apparatus of the present disclosure may further include a stop S1 and an infrared ray blocking unit IR. The stop S1 may be located between the third lens III and the fourth lens IV. The infrared ray blocking unit IR may be located between the seventh lens VII and the image sensor IMG.

The infrared ray blocking unit IR may be an infrared ray blocking filter. Positions of the stop S1 and the infrared ray blocking unit IR may be changed. The optical lens system having the above configuration according to aspects of the disclosed embodiment satisfies at least one of Conditions 1 through 6.

140≤Fov≤240, <Condition 1>

where field of view (Fov) is a diagonal viewing angle of the optical system, a unit of Fov is degrees (°). The condition is for achieving an ultra-wide-angle of the optical lens system of the present disclosure.

0≤RL1S2/RL2S2≤5, <Condition 2>

where RL1S2 is an R value of a second surface (facing the image sensor IMG) of the first lens I, and RL2S2 is an R value of a second surface of the second lens II. The condition defines shapes of the first lens I and the second lens II, and is one of features of the present disclosure for achieving high optical performance in an ultra-wide-angle optical system.

0≤ThiL5L6≤0.03, <Condition 3>

where ThiL5L6 is an interval or gap T between a second surface (exit surface) of the fifth lens V and a first surface (incident surface) of the sixth lens VI that constitute a cemented lens.

The interval is obtained by considering a gap formed naturally or inevitably when lenses are cemented or adhered, or a gap due to a thickness of a cementing material. The condition is for minimizing an aberration to improve the performance of the optical lens system.

0.15≤(L1toL2)/OAL≤0.4, <Condition 4>

where L1toL2 is a thickness from the first lens I to the second lens II, and overall length (OAL) is a thickness (length) or a height between central portions of the first lens I and the seventh lens VII.

The condition defines a sum of thicknesses of the first lens I and the second lens II with respect to a total height of the optical lens system, and is one of features of the present disclosure for achieving an ultra-wide-angle and high performance.

0.7≤Ind1/Ind7≤1.5, <Condition 5>

where Ind1 and Ind7 are refractive indices of materials of the first lens I and the seventh lens VII.

According to the condition, the first lens I is a lens having a high refractive index whereas the seventh lens VII is a lens having a low refractive index. The condition is for realizing an ultra-wide-angle optical lens system according to the present disclosure.

0.5≤Abv1/Abv7≤2, <Condition 6>

where Abv1 and Abv7 are respectively Abbe numbers of the materials of the first lens I and the seventh lens VII.

When a lens having a low Abbe number is arranged as a first lens and a lens having a high Abbe number is arranged as a last lens according to Condition 6, a chromatic aberration occurring in the ultra-wide-angle optical lens system may be minimized and high optical performance may be achieved.

Table 1 shows optical properties according to the first embodiment through the third embodiment of FIGS. 1 through 3.

TABLE 1

| | First | Second | Third |
|---|---|---|---|
| | embodi- | embodi- | embodi- |
| Definition | ment | ment | ment |
| Image Height | 4.90 | 4.90 | 4.90 |
| (IH) | | | |
| Total Track | 20.57 | 20.80 | 20.80 |
| Length (TTL) | | | |
| Overall Length | 16.57 | 17.20 | 16.80 |
| (OAL) | | | |
| Field of | 197.40 | 196.90 | 197.66 |
| view (FOV) | | | |
| Effective Focal | 1.65 | 1.65 | 1.65 |
| Length (EFL) | | | |
| Back Focal | 4.00 | 3.60 | 4.00 |
| Length (BFL) | | | |
| F Number (F | 2.08 | 2.08 | 2.08 |
| no = EFL/EPD) | | | |

In Table 1, IH is an image height of an effective diameter, TTL is a distance from a central portion of the incident surface of the first lens I to the image sensor IMG, and OAL is a distance or a height from the central portion of the incident surface of the first lens I to a central portion of the exit surface of the seventh lens VII as described above. Units of IH, TTL, and OAL are all mm. FOV is a diagonal viewing angle of the optical system.

Table 2 shows a result obtained by applying optical conditions of the first embodiment through the third embodiment of the present disclosure to Conditions 1 through 6.

TABLE 2

| | | First | Second | Third |
|---|---|---|---|---|
| Condi- | | embodi- | embodi- | embodi- |
| tion | Definition | ment | ment | ment |
| 1 | 140 < Fov < | 197.40 | 196.90 | 197.66 |
| | 240 | (Fov) | (Fov) | (Fov) |
| 2 | 0 < RL1S2/ | 1.76 | 1.53 | 1.49 |
| | RL2S2 < 5 | (RL1S2 = | (RL1S2 = | (RL1S2 = |
| | | 4.259, | 4.354, | 4.259, |
| | | RL2S2 = | RL2S2 = | RL2S2 = |
| | | 2.420) | 2.851) | 2.420) |
| 3 | 0 <ThiL5L6 < | 0.00 | 0.00 | 0.00 |
| | 0.03 | (ThiL5L6) | (ThiL5L6) | (ThiL5L6) |
| 4 | 0.15 < (L1to | 0.28 | 0.22 | 0.24 |
| | L2)/OAL < | (L1toL2 = | (L1toL2 = | (L1toL2 = |
| | 0.4 | 4.674, | 3.782, | 4.674, |
| | | OAL = | OAL = | OAL = |
| | | 16.57) | 17.20) | 16.57) |
| 5 | 0.7 < Ind1/ | 1.13 | 1.08 | 1.04 |
| | Ind7 < 1.5 | (Ind1 = | (Ind1 = | (Ind1 = |
| | | 1.773, | 1.835, | 1.773, |
| | | Ind7 = | Ind7 = | Ind7 = |
| | | 1.569) | 1.697) | 1.697) |
| 6 | 0.5 < Abv1/ | 0.89 | 0.78 | 0.89 |
| | Abv7 < 2 | (Abv1 = | (Abv1 = | (Abv1 = |
| | | 19.624, | 12.983, | 19.624, |
| | | Abv7 = | Abv7 = | Abv7 = |
| | | 56.043) | 55.459) | 55.459) |

Referring to Table 2, it is found that the optical lens system in each of the first embodiment through the third embodiment satisfies Conditions 1 through 6. Considering shapes and dimensions of the first through seventh lenses I through VII in the optical lens system having the configuration according to embodiments of the present disclosure, the first through seventh lenses I through VII may be made of plastic and, in particular, the first lens I that has a large aperture may be made of plastic having a high refractive index.

That is, all of the first lens through the seventh lens I through VII may be plastic lenses. Glass lenses have high manufacturing costs and there are limitations in forming/processing the glass lenses, thereby making it difficult to miniaturize an optical lens system. However, since all of the first through seventh lenses I through VII may be made of plastic in the present disclosure, various advantages may be obtained.

However, the present disclosure is not limited to the feature that the first lens through the seventh lens I through VII are made of plastic. If necessary, at least one of the first lens through the seventh lens I through VII may be made of glass.

The first embodiment through the third embodiment of the present disclosure will now be described in detail with reference to lens data and the attached drawings.

Each of Table 3 through Table 5 shows a radius of curvature, a lens thickness or a distance between lenses, a refractive index, and an Abbe number of each of lenses constituting the optical lens system in each of FIGS. 1 through 3.

In Table 3 through Table 5, R is a radius of curvature, D is a lens thickness, a lens interval, or an interval between adjacent elements, Nd is a refractive index of a lens measured by using a d-line, and Vd is an Abbe number of a lens with respect to a d-line. Units of R and D are mm.

TABLE 3

| First | | | | | |
|---|---|---|---|---|---|
| embodi- | Sur- | | | | |
| ment | face | R | D | Nd | Vd |
| | 1 | 12.94000 | 1.20000 | 1.77250 | 49.62353 |
| | 2 | 4.25900 | 2.47382 | | |
| | 3 | 23.91100 | 1.00000 | 1.69680 | 55.45887 |
| | 4 | 2.42000 | 1.92877 | | |
| | 5 | 8.84500 | 2.20000 | 1.92286 | 20.88000 |
| | 6 | −44.22300 | 0.86000 | | |
| | 7 | Infinity | 0.25858 | | |
| | 8 | −7.29000 | 2.17000 | 1.77250 | 49.62353 |
| | 9 | −4.95000 | 0.10000 | | |
| | 10 | 10.07400 | 2.05000 | 1.69297 | 55.45887 |
| | 11 | −2.80000 | 0.00000 | | |
| | 12 | −2.80000 | 0.55000 | 1.91038 | 20.88000 |
| | 13 | −9.05000 | 0.10000 | | |
| | 14 | 10.11900 | 1.68000 | 1.56575 | 56.04328 |
| | 15 | −10.11900 | 0.20000 | | |

TABLE 4

| Second | | | | | |
|---|---|---|---|---|---|
| embodi- | Sur- | | | | |
| ment | face | R | D | Nd | Vd |
| I | 1 | 12.66155 | 1.20000 | 1.83500 | 42.98347 |
| | 2 | 4.35352 | 2.03248 | | |
| II | 3 | 11.28079 | 0.55000 | 1.83500 | 42.98347 |
| | 4 | 2.85051 | 3.86666 | | |
| III | 5 | 6.62103 | 1.32205 | 1.91360 | 21.97108 |
| | 6 | −586.03445 | 1.08035 | | |
| Stop | 7 | Infinity | 0.30000 | | |
| IV | 8 | −5.86287 | 2.21225 | 1.86137 | 32.06912 |
| | 9 | −5.26774 | 0.10000 | | |
| V | 10 | 7.80600 | 1.93765 | 1.70953 | 53.76813 |
| | 11 | −2.80000 | 0.00000 | | |
| VI | 12 | −2.80000 | 0.55000 | 1.92286 | 20.88310 |
| | 13 | −50.00000 | 0.10000 | | |
| VII | 14 | 6.92796 | 1.94855 | 1.69680 | 55.45882 |
| | 15 | −15.00000 | 0.50000 | | |

TABLE 5

| Third | | | | | |
|---|---|---|---|---|---|
| embodi- | Sur- | | | | |
| ment | face | R | D | Nd | Vd |
| I | 1 | 11.85519 | 1.28682 | 1.77250 | 49.62353 |
| | 2 | 3.73579 | 2.14670 | | |
| II | 3 | 27.93815 | 0.55000 | 1.69680 | 55.45882 |
| | 4 | 2.50695 | 1.44614 | | |
| III | 5 | 10.69242 | 3.10939 | 1.84666 | 23.78440 |
| | 6 | −16.06698 | 0.93809 | | |
| Stop | 7 | Infinity | 0.24949 | | |
| IV | 8 | −8.59906 | 2.47882 | 1.77937 | 46.76952 |
| | 9 | −5.03938 | 0.10000 | | |
| V | 10 | 10.09598 | 2.15683 | 1.69244 | 55.73841 |
| | 11 | −2.80000 | 0.00000 | | |
| VI | 12 | −2.80000 | 0.55000 | 1.84666 | 23.78440 |
| | 13 | −18.35757 | 0.10000 | | |
| VII | 14 | 10.48902 | 1.68772 | 1.69680 | 55.45882 |
| | 15 | −10.87601 | 0.20000 | | |

All lenses of the optical lens system according to each of the first embodiment through the third embodiment of the present disclosure are spherical lenses. Accordingly, an aspheric equation is not used. However, according to the present disclosure, an aspheric surface may be applied to a specific lens.

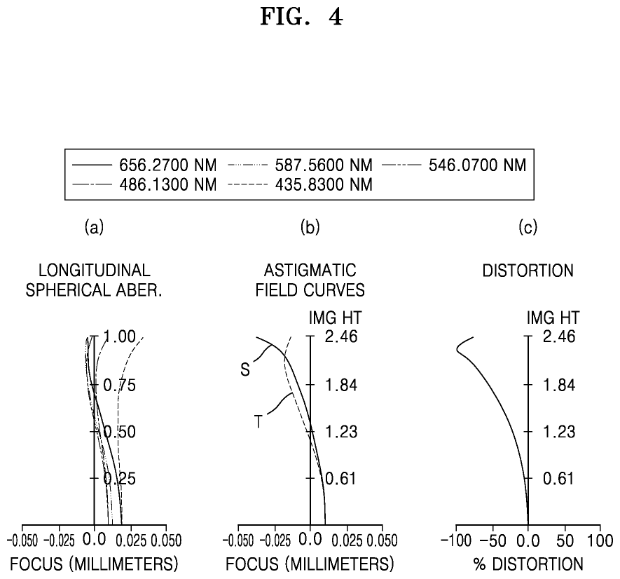

FIG. 4 illustrates a longitudinal spherical aberration, an astigmatic field curvature, and a distortion of the optical lens system according to the first embodiment (FIG. 1) of the present disclosure, that is, the optical lens system having values of Table 3.

In FIG. 4, (a) shows a spherical aberration of the optical lens system with respect to light having various wavelengths and (b) shows an astigmatic field curvature, that is, a tangential field curvature (T) and a sagittal field curvature (S), of the optical lens system.

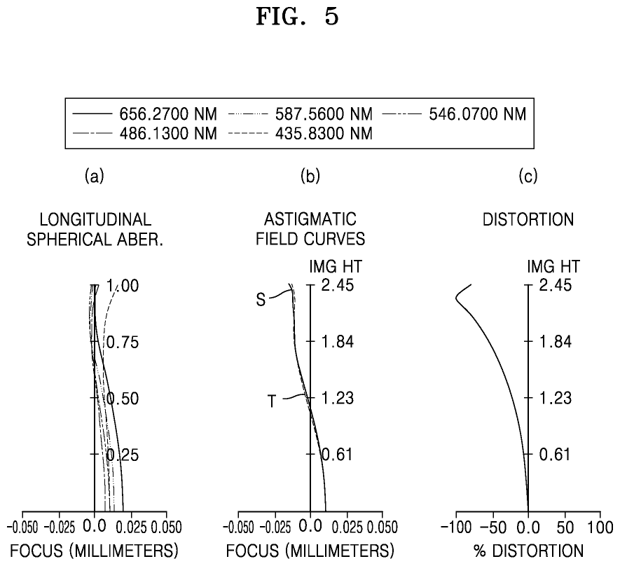

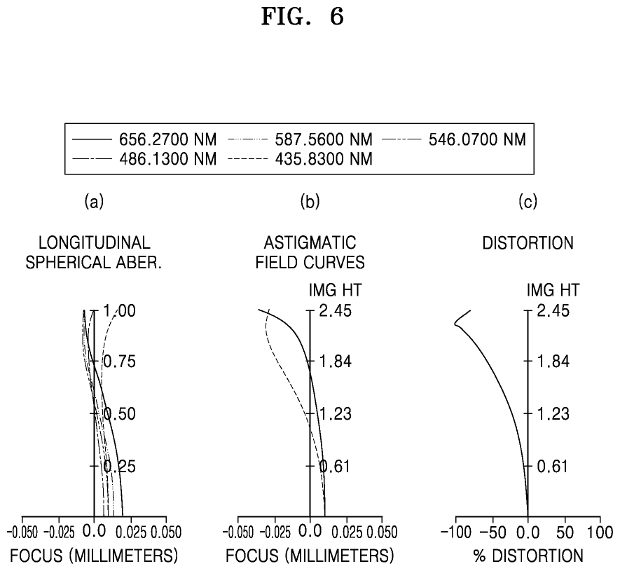

Wavelengths of light used to obtain data of (a) of FIG. 4 were 656.2700 nm, 587.6000 nm, 546.0700 nm, 486.1300 nm, and 435.8300 nm. Wavelengths of light used to obtain data of (b) and (c) were 546.1000 nm. The same wavelengths were used to obtain data in FIGS. 5 and 6.

In FIG. 5, (a), (b), and (c) respectively show a longitudinal spherical aberration, an astigmatic field curvature, and a distortion of the optical lens system according to the second embodiment (FIG. 2) of the present disclosure, that is, the optical lens system having values of Table 3.

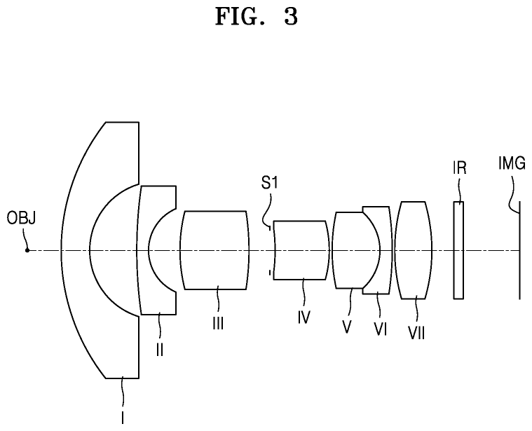

In FIG. 6, (a), (b), and (c) respectively show a longitudinal spherical aberration, an astigmatic field curvature, and a distortion of the optical lens system according to the third embodiment (FIG. 3) of the present disclosure, that is, the optical lens system having values of Table 4.

As described above, the optical lens system according to embodiments of the present disclosure may include the first lens through the seventh lens I through VII respectively having a negative (−) power, a negative (−) power, a positive (+) power, a positive (+) power, a positive (+) power, a negative (−) power, and a positive (+) power and sequentially arranged from the object OBJ to the image sensor IMG, and may satisfy at least one of Conditions 1 through 6. The optical lens system may easily (satisfactorily) correct various aberrations and may have a relatively short total length. Accordingly, according to an embodiment of the present disclosure, the ultra-wide-angle optical lens system that may have a small size, high performance, and a high resolution may be realized.

In particular, according to embodiments of the present disclosure, in data of a surface 11 of the fifth lens V in Tables 3 through 5, there is no interval T (“0”) between the fifth lens and the sixth lens of the optical lens system. However, according to another embodiment of the present disclosure, the interval T may be adjusted in a range from 0 to 0.03 mm.

As described above, the fifth lens has a positive (+) power, the sixth lens has a negative (−) power, and a sum of powers of the fifth lens V and the sixth lens VI, has a negative value. That is, a cemented lens formed by the fifth lens V having a positive (+) power and the sixth lens VI having a negative (−) power has a negative (−) power.

The first lens through the seventh lens I through VII may be made of plastic, and at least the first lens from among the first through seventh lenses I through VII may be made of plastic. Also, the first lens I may have a spherical lens, instead of an aspheric lens, and may have a refractive index higher than that of the second lens II.

According to the present disclosure, all of the lenses may be made of plastic, and thus the optical lens system having a small size and excellent performance may be realized with costs less than that of using glass lenses.

While the present disclosure has been particularly shown and described with reference to embodiments thereof, the embodiments have merely been used to explain the present disclosure and should not be construed as limiting the scope of the present disclosure as defined by the claims. For example, it will be understood by one of ordinary skill in the art that any of various additional elements, instead of a filter, may be used as the infrared ray blocking unit. Various other modifications may be made. Accordingly, the scope of the present disclosure is defined not by the detailed description of the present disclosure but by the appended claims.

What is claimed is:

1. An optical lens system comprising a first lens, a second lens, a third lens, a fourth lens, a fifth lens, a sixth lens, and a seventh lens that are sequentially arranged along an optical axis between an object and an image plane, each of the first to seventh lenses comprising an incident surface facing the object and an exit surface facing the image plane,
wherein each of the first lens, the second lens, and the sixth lens has a negative (−) power,
each of the third lens, the fourth lens, the fifth lens, and the seventh lens has a positive (+) power, and
the fifth lens and the sixth lens are cemented together to form a cemented lens having a positive (+) power,
the first lens has a refractive index higher than a refractive index of the seventh lens, and the optical lens system satisfies Condition 1,
140≤Fov≤240, <Condition 1>
where field of view (Fov) is a diagonal viewing angle of the optical lens system.

2. The optical lens system of claim 1, wherein the optical lens system satisfies Condition 2,
0≤RL1S2/RL2S2≤5, <Condition 2>
where RL1S2 is a curvature (R) value of a second surface of the first lens, and RL2S2 is an R value of a second surface of the second lens, wherein the second surface of the first lens faces an image sensor.

3. The optical lens system of claim 1, wherein the optical lens system satisfies Condition 3,
0≤ThiL5L6≤0.03, <Condition 3>
where ThiL5L6 is an interval or a gap (T) between a second surface of the fifth lens and a first surface of the sixth lens.

4. The optical lens system of claim 1, wherein the optical lens system satisfies Condition 4,
0.15≤(L1toL2)/OAL≤0.4, <Condition 4>
where L1toL2 is a thickness from the first lens to the second lens, and an overall length (OAL) is a thickness (length) between a central portion of the first lens and a central portion of the seventh lens.

5. The optical lens system of claim 1, wherein the optical lens system satisfies Condition 5,
0.7≤Ind1/Ind7≤1.5, <Condition 5>
where Ind1 and Ind7 are respectively refractive indices of materials of the first lens and the seventh lens.

6. The optical lens system of claim 2, wherein the optical lens system further satisfies Condition 5,
0.7≤Ind1/Ind7≤1.5, <Condition 5>
where Ind1 and Ind7 are respectively refractive indices of materials of the first lens and the seventh lens.

7. The optical lens system of claim 3, wherein the optical lens system further satisfies Condition 5,
0.7≤Ind1/Ind7≤1.5, <Condition 5>
where Ind1 and Ind7 are respectively refractive indices of materials of the first lens and the seventh lens.

8. The optical lens system of claim 4, wherein the optical lens system further satisfies Condition 5,
0.7≤Ind1/Ind7≤1.5, <Condition 5>
where Ind1 and Ind7 are respectively refractive indices of materials of the first lens and the seventh lens.

9. The optical lens system of claim 5, wherein the optical lens system further satisfies Condition 6,
0.5≤Abv1/Abv7≤2, <Condition 6>
where Abv1 and Abv7 are respectively Abbe numbers of the materials of the first lens and the seventh lens.

10. The optical lens system of claim 6, wherein the optical lens system further satisfies Condition 6,
0.5≤Abv1/Abv7≤2, <Condition 6>
where Abv1 and Abv7 are respectively Abbe numbers of the materials of the first lens and the seventh lens.

11. The optical lens system of claim 7, wherein the optical lens system further satisfies Condition 6,
0.5≤Abv1/Abv7≤2, <Condition 6>
where Abv1 and Abv7 are respectively Abbe numbers of the materials of the first lens and the seventh lens.

12. The optical lens system of claim 8, wherein the optical lens system further satisfies Condition 6,
0.5≤Abv1/Abv7≤2, <Condition 6>
where Abv1 and Abv7 are respectively Abbe numbers of the materials of the first lens and the seventh lens.

13. The optical lens system of claim 1, further comprising a stop located between the third lens and the fourth lens.

14. The optical lens system of claim 2, further comprising a stop located between the third lens and the fourth lens.

15. The optical lens system of claim 3, further comprising a stop located between the third lens and the fourth lens.

16. The optical lens system of claim 4, further comprising a stop located between the third lens and the fourth lens.

17. An optical lens system comprising:
a first lens having a negative (−) power and comprising an exit surface that is concave away from an image plane;
a second lens having a negative (−) power and comprising an exit surface that is concave away from the image plane;
a third lens having a positive (+) power and comprising an incident surface that is convex toward an object;
a fourth lens having a positive (+) power and comprising an exit surface that is convex toward the image plane;
a fifth lens having a positive (+) power and comprising an exit surface that is convex toward the image plane;
a sixth lens having a negative (−) power, comprising an incident surface that is concave away from the object, and cemented with the fifth lens to form a cemented lens having a positive (+) power; and
a seventh lens having a positive (+) power and comprising an incident surface that is convex toward the object,
wherein the optical lens system satisfies at least one of Conditions 1 through 6,
140≤Fov≤240, <Condition 1>
where field of view (Fov) is a diagonal viewing angle of the optical lens system,
0≤RL1S2/RL2S2≤5, <Condition 2>
where RL1S2 is a curvature (R) value of a second surface of the first lens, and RL2S2 is an R value of a second surface of the second lens, wherein the second surface of the first lens faces an image sensor,
0≤ThiL5L6≤0.03, <Condition 3>
where ThiL5L6 is an interval or a gap (T) between a second surface of the fifth lens and a first surface of the sixth lens that constitute the cemented lens,
0.15≤(L1toL2)/OAL≤0.4, <Condition 4>
where L1toL2 is a thickness from the first lens to the second lens, and an overall length (OAL) is a thickness (length) between a central portion of the first lens and a central portion of the seventh lens,
0.7≤Ind1/Ind7≤1.5, <Condition 5>
where Ind1 and Ind7 are respectively refractive indices of materials of the first lens and the seventh lens, and
0.5≤Abv1/Abv7≤2, <Condition 6>
where Abv1 and Abv7 are respectively Abbe numbers of the materials of the first lens and the seventh lens.

18. The optical lens system of claim 17, further comprising a stop located between the third lens and the fourth lens.
